(19) United States
(12) Patent Application Publication
(10) Pub. No.: US 2007/0255639 A1
(43) Pub. Date: Nov. 1, 2007

(54) Automated Money Management Systems and Methods

(75) Inventor: Dean Seifert, Foxrock (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/682,808

(22) Filed: Mar. 6, 2007

Related U.S. Application Data
(60) Provisional application No. 60/787,979, filed on Mar. 31, 2006.

(51) Int. Cl. G06Q 40/00

(52) U.S. Cl. 705/36 R

(57) ABSTRACT

A system for managing an employee's funds, where the system may include an employee interface, a payroll system, and a reporting system. The employee interface may be configured to receive an instruction from an employee and transmit directions which are based at least in part upon the instruction. The instruction may include a first identifier representing a payee and an amount of funds to be directed to the payee. The payroll system may be configured to receive directions transmitted from the employee interface, and based at least in part upon the directions, direct an amount of funds from an employer to the payee and to the employee. The reporting system may be configured to produce a report. The report may include a statement of the amount of funds directed from the employer to the payee and the amount of funds directed from the employer to the employee.

### PRIORITY CLAIM

This application claims priority to Provisional U.S. Patent Application No. 60/787,979 filed Mar. 31, 2006, entitled “Automated Money Management Systems and Methods,” the entire disclosure of which is hereby incorporated by reference as if fully set forth herein.

### BACKGROUND

Embodiments of the present invention pertain generally to financial systems, and more particularly to payroll systems. Payroll systems are commonly used to calculate and distribute amounts of funds from an employer to an employee. Normally, the payroll system might calculate the amount of pay due to the employee from the employer as well as deductions from that amount for such things as tax and other authorized withholdings. The payroll system then causes a check to be delivered to the employee or a direct deposit of funds into an account under the control of the employee at a financial institution.

As is common in personal finances, the employee might then receive, from time to time, statements of amounts due to various creditors such as a telephone service provider, a credit card company and/or a housing provider. The employee might then write out checks or use an online bill pay system to pay each of these creditors. The process of paying each creditor using these traditional means might be time consuming for the employee. Additionally, this process allows numerous opportunities for errors by the employee in making payments which may result in incomplete or unsuccessful payments to the creditors, possibly resulting in default on the underlying obligations. The systems and methods of the present invention provide solutions to these and other problems.

### BRIEF DESCRIPTION OF THE INVENTION

In some embodiments, the invention provides a system for managing an employee's funds. The system may include an employee interface which may be configured to receive an instruction from an employee and transmit directions. The directions may be based at least in part upon the instruction received from the employee. The employee interface may be a computer and receiving the instruction from an employee may include the employee directly inputting the instruction into the employee interface and/or the employee writing the instruction and another person inputting the instruction into the employee interface.

The instruction may include a first identifier representing a payee and an amount of funds to be directed to the payee. The first identifier may be an alpha-numeric code corresponding to the payee, the payee's name, and/or the payee's address. The payee may be an individual or a business entity. The instruction may further include a second identifier representing an account payable to the payee and associated with the employee. The instructions may also include a date.

The system may also include a payroll system which may be configured to: receive directions from the employee interface; based at least in part upon the directions, direct an amount of funds from the employer to the payee; and based at least in part upon the directions, direct an amount of funds from the employer to the employee. The payroll system may be configured to direct the amount of fund from the employer to the payee relative to a date included in the instructions. Directing the amount of funds from the employer to the employee may be accomplished by, merely by way of example, producing at least one check payable to the employee and/or depositing the amount of funds into at least one account held by the employee at a financial institution.

The system may also include a reporting system which may be configured to produce a report. The report may include a statement of the amount of funds directed from the employer to the payee and a statement of the amount of funds directed from the employer to the employee. The report may possible include a paper report, a pay stub, an electronic report transmitted by e-mail to the employee and/or an electronic report viewable by the employee through a computer.

In some embodiments, the system may also include a bill-pay system. Directing the amount of funds from the employer to the payee in these embodiments may include the payroll system transmitting information for reception by the bill-pay system. The bill-pay system may be configured to receive the information and direct the amount of funds from the employer to the payee based at least in part upon the information.

In other embodiments, the invention provides a different system for managing an employee's funds. The system may include an employee interface which may be configured to receive an instruction from an employee and transmit directions. The directions may be based at least in part upon the instruction received from the employee. The instruction may include a first identifier representing a payee to whom the employee owes an obligation. The obligation may also have a due-date associated therewith. The instruction may further include a second identifier representing an account payable to the payee and associated with the employee. The instructions may also include a date.

The system may also include a payroll system which may be configured to: receive directions from the employee interface; based at least in part upon the directions and the obligation owed to the payee by the employee, direct an amount of funds from the employer to the payee; and based at least in part upon the directions and the obligation owed to the payee by the employee, direct an amount of funds from the employer to the employee. The payroll system may be configured to direct the amount of fund from the employer to the payee relative to a date included in the instructions or possibly a due-date associated with the obligation. Directing the amount of funds from the employer to the employee may be accomplished by, merely by way of example, producing at least one check payable to the employee and/or depositing the amount of funds into at least one account held by the employee at a financial institution.

The system may also include a reporting system which may be configured to produce a report. The report may include a statement of the amount of funds directed from the employer to the payee and a statement of the amount of funds directed from the employer to the employee.

In another possible embodiment, the invention provides a method for managing an employee's funds. The method may include receiving, at an employee interface, an instruction. The instruction may include a first identifier representing a payee and an amount of funds to be directed to the payee. The instruction may also include a second identifier representing an account payable to the payee and associated with the employee.

The method may also include transmitting, from the employee interface, directions based at least in part upon the instruction received from the employee. The method may receive, at a payroll system, the directions. The payroll system may direct both an amount of funds from the employer to the payee, and an amount of funds from the employer to the employee, based at least in part upon the directions. The amount of funds directed from the employer to the payee may be equal to an amount of an obligation owed to the payee by the employee. The obligation may have a due-date associated therewith, and the payroll system may be configured to direct the amount of funds from the employer to the payee relative to the due-date.

In some embodiments, the directing, at the payroll system, the amount of funds from the employer to the payee may include: transmitting, from the payroll system, information for reception by a bill-pay system; receiving, at the bill-pay system, the information; and directing, at the bill-pay system, an amount of funds from the employer to the payee based at least in part upon the information transmitted from the pay roll system. The method may also include reporting the amount of funds directed from the employer to the payee and the amount of funds directed from the employer to the employee.

### BRIEF DESCRIPTION OF THE DRAWINGS

The present disclosure is described in conjunction with the appended figures:

FIG. 1 is a block diagram of a system for managing an employee's funds which includes an employee interface, a payroll system and a reporting system, where the employee directly inputs an instruction into the employee interface;

FIG. 2 is a block diagram of the system in FIG. 1, except showing the employee giving written instructions to another person who inputs the instructions into the employee interface;

FIG. 3 is a block diagram of the system in FIG. 2, except including a bill-pay system, which, using information from the payroll system, transfers funds from an employer to a payee;

FIG. 4 is sample set of instructions, shown as written instructions to be inputted into an employee interface by another person;

FIG. 5 is a sample set of reports, shown as a pay stub;

FIG. 6 is a block diagram of an exemplary computer system capable of being used in at least some portion of the systems of the present invention, or of implementing at least some portion of the methods of the present invention;

FIG. 7 is a flow diagram of a method for managing an employee's funds that uses another person to input instructions, and both a bill-pay system and a payroll system to direct funds;

FIG. 8 is a flow diagram of the method in FIG. 7, except not using another person to input instructions;

FIG. 9 is a flow diagram of the method in FIG. 8, except only using the bill-pay system to direct funds to a payee;

FIG. 10 is a flow diagram of the method in FIG. 7, except only using the payroll system to direct funds; and

FIG. 11 is a flow diagram of the method in FIG. 10, except only transmitting a report electronically without producing a physical report.

In the appended figures, similar components and/or features may have the same reference label. Further, various components and/or features of the same type may be distinguished by following the reference label by a letter that distinguishes among the similar components and/or features. If only the first reference label is used in the specification, the description is applicable to any one of the similar components and/or features having the same first reference label irrespective of the letter suffix.

### DETAILED DESCRIPTION OF THE INVENTION

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing a preferred exemplary embodiment. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instructions and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor or processors may perform the necessary tasks.

In some embodiments, the invention provides a system for managing an employee's funds. The system may include an employee interface which may be configured to receive an instruction from an employee and transmit directions. The directions may be based at least in part upon the instruction received from the employee. In some embodiments, the directions may be the exact same data contained in the instruction, in the exact same form or organization. In other possible embodiments, the directions may contain only a very limited portion of the instruction in a completely reorganized fashion.

The employee interface may be a computer and receiving the instruction from an employee may include the employee directly inputting the instruction into the employee interface and/or the employee writing the instruction and another person inputting the instruction into the employee interface. In embodiments where the employee writes the instruction and another person inputs the instruction, the instruction may be written onto a prescribed form, and the other person might possibly be an administrative and/or human-resource employee of the employer.

The instruction may include a first identifier representing a payee and an amount of funds to be directed to the payee. The first identifier may be an alpha-numeric code corresponding to the payee, the payee's name, and/or the payee's address. The payee may be an individual or a business entity. The instruction may further include a second identifier representing an account payable to the payee and associated with the employee. The instructions may also include a date. The instruction might also include some data relating to how long, or for how many pay cycles for which the instruction will remain valid.

Merely by way of example, the payee could be a public utility company which delivers power, gas, water, sewage or other services to the employee; some other service provider such as a satellite television provider, cable company provider, internet provider, telephone service provider, mobile phone service provider, satellite radio provider; a cleaning service, a lending institution servicing an installment loan such as a mortgage company or bank; and/or a credit card company servicing a VISA™, Mastercard™, Discover™ or American Express™ account. Other possible payees could include individuals or companies to whom non-recurring payments are owed.

The employee interface, when including a computer could also include software running on the computer which produces a textual or graphical interface. The employee or another person may use such interfaces to enter the instruction. The computer could be any one of a number of devices including, but not limited to, a mobile phone, a personal data assistant, a mobile messaging device, a laptop computer, a notebook computer, a desktop computer, a network computer terminal, or a financial services kiosk. Additionally, a web interface or web browser may be employed in some embodiments to provide the user interface. The web interface or web browser may access intranet and/or Internet web sites to provide the user interface. In some embodiments the user interface might be configured within a financial services kiosk, possibly at a financial services location such as a bank or money transfer service office. In these or other configurations, additional data might be contained in an instruction inputted by the employee or other person pertaining to the identity of the employer and possibly security data to insure that the user of the interface is, in fact, the employee or another person who is authorized to input an instruction. Financial services kiosks are discussed in greater detail in U.S. patent application Ser. No. 10/225,410, entitled “MULTI-PURPOSE KIOSK AND METHODS,” filed Aug. 20, 2002, by Paul A. Blair, Kenneth Algiene and Mark Thompson; and U.S. patent application Ser. No. 11/100,327, entitled “INTEGRATING TRANSACTION FEATURES INTO A POS SYSTEM,” filed Apr. 5, 2005, by Douglas Byerley and Timothy Maurer, which applications are herein incorporated by reference in their entirety for all purposes.

The employee interface could be located at any number of locations. The employee interface might be accessible anywhere, possibly depending on the manner in which the interface is provided. For example, embodiments using the Internet might provide a wide range of locations where the employee interface could be accessed including the employee's home or the employer's place of business. On the other hand, embodiments using the stand-alone-kiosk might make the employee interface available at independent third-party locations, as well as the employer's place of business.

The employee interface, or a system in communication therewith, may also be configured, in some embodiments, to store an instruction received by an employee. The instruction may be stored so as to be referenced later by the employee or some other person. Referencing the instruction may be advantageous in embodiments that allow for modification of a past instruction. This might allow an employee or another person to only change parts of an instruction that require changing. For example, if the employee inputs an instruction having a payee's name, an amount of funds to be directed to the payee, and an identifier representing an account payable to the payee and associated with the employee, the employee interface, or a system in communication therewith, may store the instruction. In this example, the employee may recall the instruction, change any one or more parts of the instruction and resubmit the instruction without having to re-input the unchanged part or parts of the instruction.

The system may also include a payroll system which may be configured to: receive directions from the employee interface; based at least in part upon the directions, direct an amount of funds from the employer to the payee; and based at least in part upon the directions, direct an amount of funds from the employer to the employee. Directions received by the payroll system may be stored by the payroll system or a system in communication therewith. The directions may be stored so as to be referenced later by the payroll system, the employee, or some other person. In some embodiments, stored directions may be associated with triggers that are responsive to changes in a date and/or time as included in the instruction from which the directions were created. When a certain date and/or time occurs, the payroll system may direct funds as specified by the triggered directions. Referencing the directions may also be advantageous in embodiments that allow for modification of past directions. This might allow an employee or other person to only change parts of directions that require changing by entering parts of an instruction that are intended only to modify a parts of the directions.

The payroll system may be configured to direct the amount of funds from the employer to the payee relative to a date included in the instruction, and thereby possibly disclosed in the indirections which may be based at least in part upon the instruction. Directing the amount of funds from the employer to the employee may be accomplished by, merely by way of example, producing at least one check payable to the employee and/or depositing the amount of funds into at least one account held by the employee at a financial institution.

The payroll system may, in some embodiments, be configured to conduct additional operations such as calculating and withholding, state and federal income taxes, social security payments, medicate payments, costs pertaining to employee benefits and expenses such as health insurance, retirement plans, parking, commuting services and/or uniform cleaning services. Additionally, in some embodiments, the payroll system may be configured to calculate the funds due to an employee from the employer before any withholdings. The payroll systems of the invention may also be configured to communicate with banks and other financial institutions associated with the employer and the employee. Payroll systems are discussed in greater detail in U.S. Pat. No. 6,829,588, entitled “ELECTRONIC PAYROLL SYSTEM AND METHOD,” issued on Dec. 12, 2004, to Earney E. Stoutenburg and Dean A. Seifert which is herein incorporated by reference in its entirety for all purposes.

The system may also include a reporting system which may be configured to produce a report. The report may include a statement of the amount of funds directed from the employer to the payee and a statement of the amount of funds directed from the employer to the employee. The report may possibly include a paper report, a pay stub, an electronic report transmitted by e-mail to the employee and/or an electronic report viewable by the employee through a computer.

In some embodiments, the system may also include a bill-pay system. Directing the amount of funds from the employer to the payee in these embodiments may include the payroll system transmitting information for reception by the bill-pay system. The information might include an identifier representing the payee or other data allowing the payee to be specified by the information. The information may also include financial information such as routing and account numbers that allow the bill-pay system to identify where funds should be directed from and to.

The bill-pay system may be configured to receive the information and direct the amount of funds from the employer to the payee based at least in part upon the information. In some embodiments, the bill-pay system may transmit a confirmation message to the payroll system to verify that funds have been and/or will be directed from the employer to the payee. Bill-pay systems are discussed in greater detail in U.S. patent application Ser. No. 10/696,767, entitled “POINT OF SALE SYSTEMS AND METHODS FOR CONSUMER BILL PAYMENT,” filed Oct. 19, 2004, by Erik S. Crawford and Thomas B. Sayor which is herein incorporated by reference in its entirety for all purposes.

In other embodiments, the invention provides a different system for managing an employee's funds. The system may include an employee interface which may be configured to receive an instruction from an employee and transmit directions. The directions may be based at least in part upon the instruction received from the employee. The instruction may include a first identifier representing a payee to whom the employee owes an obligation. The obligation may also have a due-date associated therewith. The instruction may further include a second identifier representing an account payable to the payee and associated with the employee. The instructions may also include a date.

The system may also include a payroll system which may be configured to: receive directions from the employee interface; based at least in part upon the directions and the obligation owed to the payee by the employee, direct an amount of funds from the employer to the payee; and based at least in part upon the directions and the obligation owed to the payee by the employee, direct an amount of funds from the employer to the employee. The payroll system may be configured to direct the amount of funds from the employer to the payee relative to a date included in the instructions, and possibly therefore, included in the directions received by the payrolls system. The payroll system may also possibly be configured to direct the amount of funds from the employer to the employee due-date associated with the obligation. The due-date and the amount of the obligation may, in some embodiments, possibly be obtained through various means, possibly by communication with the payee or a system associated therewith, a bill-pay system or a system associated therewith, or the employee.

Directing the amount of funds from the employer to the employee may be accomplished by, merely by way of example, producing at least one check payable to the employee and/or depositing the amount of funds into at least one account held by the employee at a financial institution. In some examples the employee may instruct the system to split funds remaining after direction of funds to payees into different checks and deposits into various accounts as a method of managing personal finances. For instance, the employee may have the system deposit funds into one account for necessities such as mortgage and grocery payments, into another for emergency savings, and issue a check for the remaining funds for use as discretionary funds.

The system may also include a reporting system which may be configured to produce a report. The report may include a statement of the amount of funds directed from the employer to the payee and a statement of the amount of funds directed from the employer to the employee.

In another possible embodiment, the invention provides a method for managing an employee's funds. The method may include receiving, at an employee interface, an instruction. The instruction may include a first identifier representing a payee and an amount of funds to be directed to the payee. The instruction may also include a second identifier representing an account payable to the payee and associated with the employee.

The method may also include transmitting, from the employee interface, directions based at least in part upon the instruction received from the employee. The method may receive, at a payroll system, the directions. The payroll system may direct both an amount of funds from the employer to the payee, and an amount of funds from the employer to the employee, based at least in part upon the directions. The amount of funds directed from the employer to the payee may be equal to an amount of an obligation owed to the payee by the employee. The obligation may have a due-date associated therewith, and the payroll system may be configured to direct the amount of funds from the employer to the payee relative to the due-date.

In some embodiments, the directing, at the payroll system, the amount of funds from the employer to the payee may include: transmitting, from the payroll system, information for reception by a bill-pay system; receiving, at the bill-pay system, the information; and directing, at the bill-pay system, an amount of funds from the employer to the payee based at least in part upon the information transmitted from the pay roll system. The method may also include reporting the amount of funds directed from the employer to the payee and the amount of funds directed from the employer to the employee.

In embodiments where the employee specifies a future due-date or other date, and when direction of funds from the employer to the payee occurs relative to such date, the funds may be in varying party's possession during the interim time period depending on the embodiment. In some embodiments, the funds may be directed to the employee via an electronic deposit, with the bill-pay system scheduling a direction of the funds from the employee to the payee relative to the future date. In other embodiments, the funds may be retained by the employer until either the payroll system or bill-pay system directs the funds from the employer to the payee. Yet in still other embodiments, the funds may be transferred to some entity associated with the payroll system during the interim period between distribution by the employer and directing of the funds to the payee. Other possible configurations are possible even though not specifically discussed here.

In each of these possible exemplary possible embodiments of the invention, interest might possibly accumulate on the funds when they are held by the various entities. This interest may, depending on which embodiment is implemented, the policies of the various entities, and the applicable laws of where the invention is implemented, accumulate to the benefit of any of the above mentioned parties including the employee, the employer, an entity associated with the bill-pay system, an entity associated with the payroll system or others. A benefit to the employee in any of these or other embodiments might be that funds otherwise obtained at a pay date are pre-allocated to paying bills and other obligations that will come due, eliminating the possibility that the funds will be spent elsewhere before such time and be unavailable to pay inflexible time and amount constrained bills or obligations. In other embodiments, the employee may instruct that funds to be immediately transferred when they are available from the employer, possibly before the due-date of obligations which the funds will go to satisfy. In these embodiments, payment of fixed-payment installment obligations ahead of due-dates may accelerate repayment of the total obligation, reducing the amount of interest paid over the life of repayment.

In some embodiments, the entity associated with the payroll system may charge the employer a fee to provide direction of funds from the employer to payees and/or the employee. In these or other embodiments, the entity associated with the payroll system may charge the employee on a per-transactional or flat-fee basis. In some embodiments, no charge will be made by the entity associated with the payroll system because revenue is being derived from interest on funds as discussed above.

In some embodiments, the systems and methods of the invention may aggregate multiple instructions from an employee. In these embodiments, an employee may input multiple directions into the employee interface. The directions transmitted from the employee interface to the payroll system may be based at least in part upon these instructions. The payroll system may then direct an amount of funds from the employer to each of the payees, possibly by employing the bill-pay system described above. The reporting system may then produce a report which includes a statement of the amount of funds directed to each payee.

In these or other embodiments, the systems and methods of the invention may aggregate multiple instructions from multiple employees of multiple employers, and direct funds to multiple payees. It will now be apparent to those skilled in the art that the systems and methods of the invention can be scaled in numerous fashions to benefit different numbers of employees, payees, and/or employers. As the systems and methods of the invention are scaled further upwards there may be reduced transaction costs for the payees in receiving funds from the employees, which may be passed on to the employees in the form of incentives such as reductions on obligations owed by the employer to the employee and/or new services or goods at a reduced prices for the employee. Even when only one employee uses the employee interface to initiate directing of funds from the employer to a payee, the payee may offer incentives to the employee because the payee is assured of being one of the first to be paid by the employee after receiving pay from the employer.

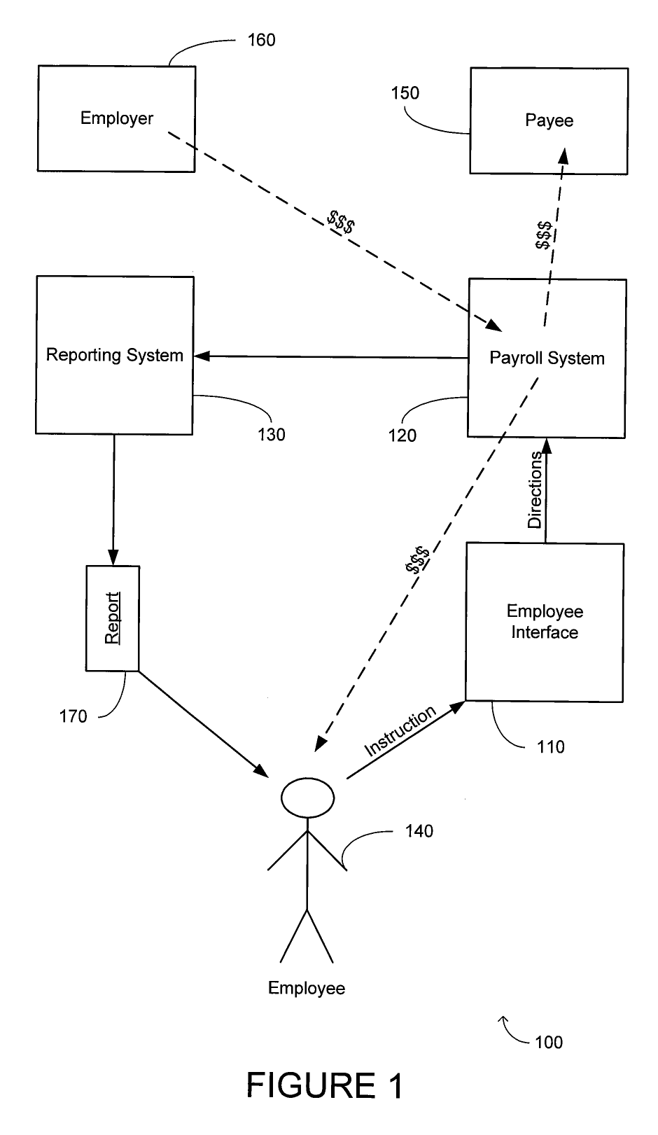

Referring now to FIG. 1, a block diagram 100 of a system for managing an employee's funds is shown which includes an employee interface 110, a payroll system 120 and a reporting system 130. In this system, an employee 140 directly inputs an instruction into the employee interface 110. By way of example, the instruction includes an identifier representing a payee 150 and an amount of funds to be directed from an employer 160 to the payee 150.

The employee interface 110 creates directions based upon the instruction and transmits the directions to the payroll system 120. When a pay date occurs, the payroll system 120 receives the directions and directs funds from the employer 160 to the payee 150 based on the directions. The payroll system 120 directs the remainder of the funds from the employer 160 to the employee 140 and then transmits report information to the reporting system 130. The reporting system 130 creates a paper report 170 that is delivered to the employee 140.

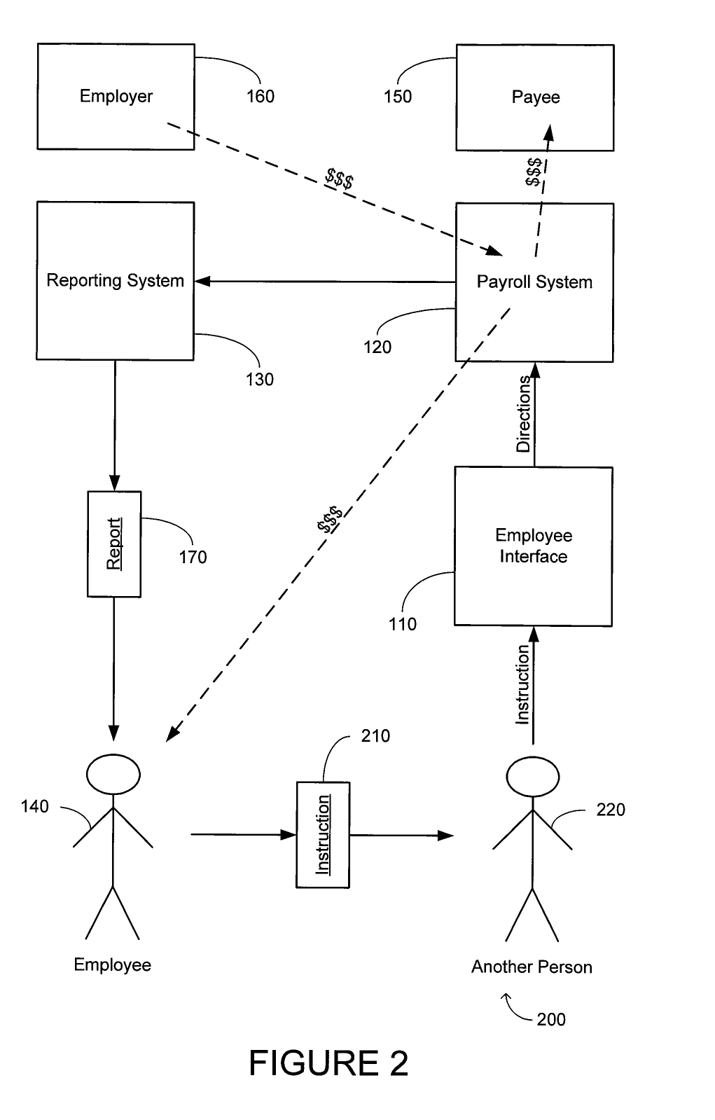

FIG. 2 is a block diagram 200 of the system in FIG. 1, except showing the employee 140 giving a written instruction 210 to another person 220 who inputs the instruction into the employee interface 110. As discussed above, the other person may be a human resources administrator at the employer's location who receives form containing instructions from multiple employees and is responsible for inputting them into the employee interface.

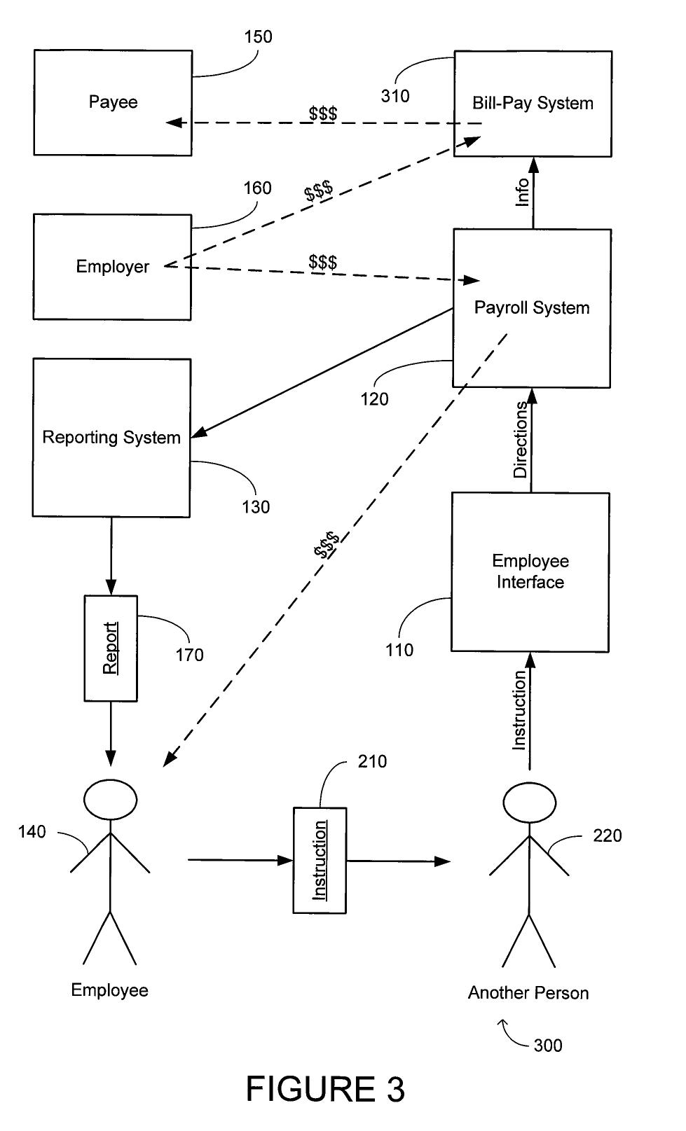

FIG. 3 is a block diagram 300 of the system in FIG. 2, except including a bill-pay system 310, which, using information from the payroll system 120, directs funds from an employer 160 to a payee 150. This embodiment may be advantageous when access to a bill-pay system 310 is available and directing the funds at the bill-pay system 310 is more efficient than the payroll system 120 directing the funds from the employer 160 to the payee 150. Some embodiments using the system of FIG. 3 may also involve both the bill-pay system 310 and the payroll system 120 directing funds to the same or different payees 150.

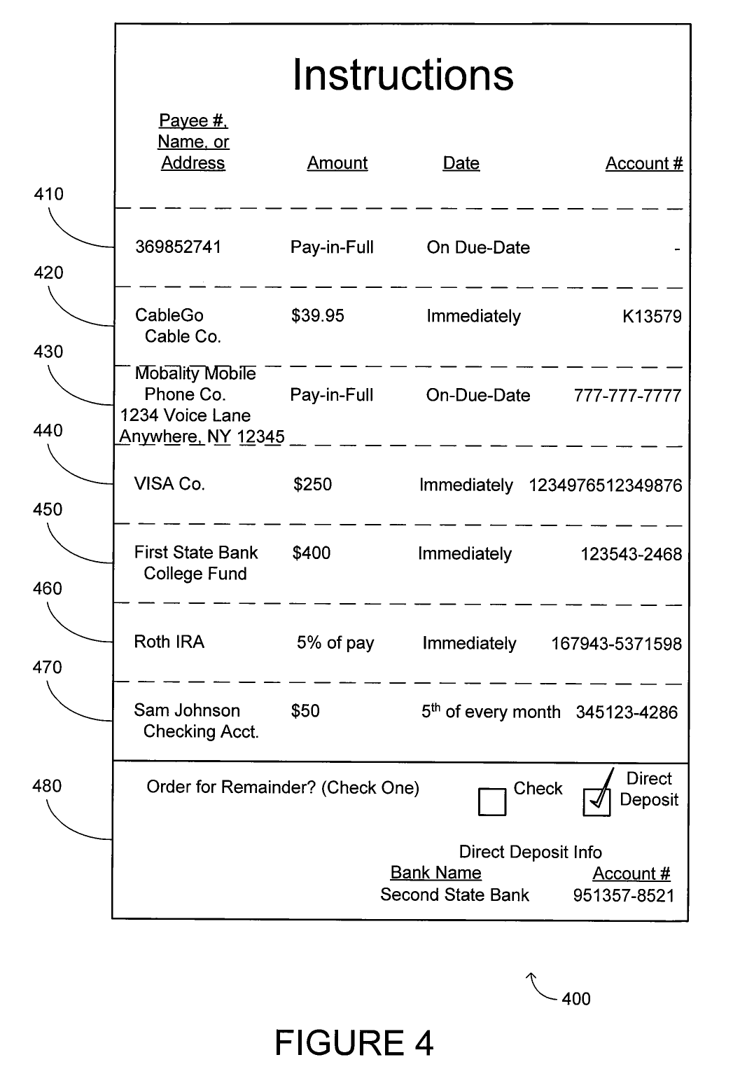

FIG. 4 is sample set 400 of instructions 410, 420, 430, 440, 450, 460, 470, shown as written instructions to be inputted into an employee interface 110 by another person. FIG. 4 may be representative of a prescribed from used by an employer 160 for all employees 140. The first instruction 410 in the set 400 is to direct an amount of funds to the payee 150 represented by the number “369852741” that will “pay-in-full” the obligation owed to the payee 150. The instruction also specifies a date on which to direct the funds, “On Due-Date.” This instruction contains no identifier representing an account payable to the payee 150 and associated with the employee 140. The second instruction 420 is to direct $39.95 to the CableGo Cable Co. immediately and that there is an account payable to the payee 150, and associated with the employee 140, which is represented by the identifier “K13579.” The third instruction 430 includes the address of the payee 150, which may be necessary in some embodiments to direct the funds to the payee 150. Some embodiments may, for example, use this information to produce a physical check payable to the payee 150 and thereafter mail the check the payee 150 at the address given.

In the fourth instruction 440 the date at which the funds are to be directed is labeled as “immediately.” In some embodiments, not including a date in the instruction might be assumed by the methods and systems of the invention to mean the funds should be directed immediately. In other embodiments, no date being included in the instruction might be assumed to mean that the funds should be directed on the due-date of the underlying obligation, if one exists.

In the fifth instruction 450, funds are directed toward an account at a bank, possibly held by the employee 140. The fifth instruction 450 demonstrates how one possible payee 150 in some of the embodiments of the invention might be an account held by the employee 140. In other embodiments, the direction of funds to an employee 140 controlled account may be conducted as one of a plurality of directing of funds to the employee 140, rather than a payee 150 which represents an account held by the employee 140. The employee 140, may, as in this instruction, wish to save funds for a certain purpose (in this example a college fund), and use the systems and methods of the invention to do so. In the sixth instruction 460, another employee 140 held account is referred to. In the sixth instruction 460, the amount of funds to be directed is specified as a percentage of the pay. This example illustrates that numerous methods are possible, within the scope of the invention, to specify the amount of funds to be directed. In the seventh instruction 470, funds are directed to an individual and the date specified is a date in reference to the calendar month.

An order 480 for the remainder of funds due to an employee 140 from a pay period is shown at the bottom of the set 400 of instructions. In this example, the order 480 section of the instructions form allows the employee 140 to have the remainder of funds from a pay period to be directed either to a paper check made out the employee 140 or a deposit directly into an account held the employee 140. The form in FIG. 4 also allows for relevant information regarding a direct deposit request to be inserted.

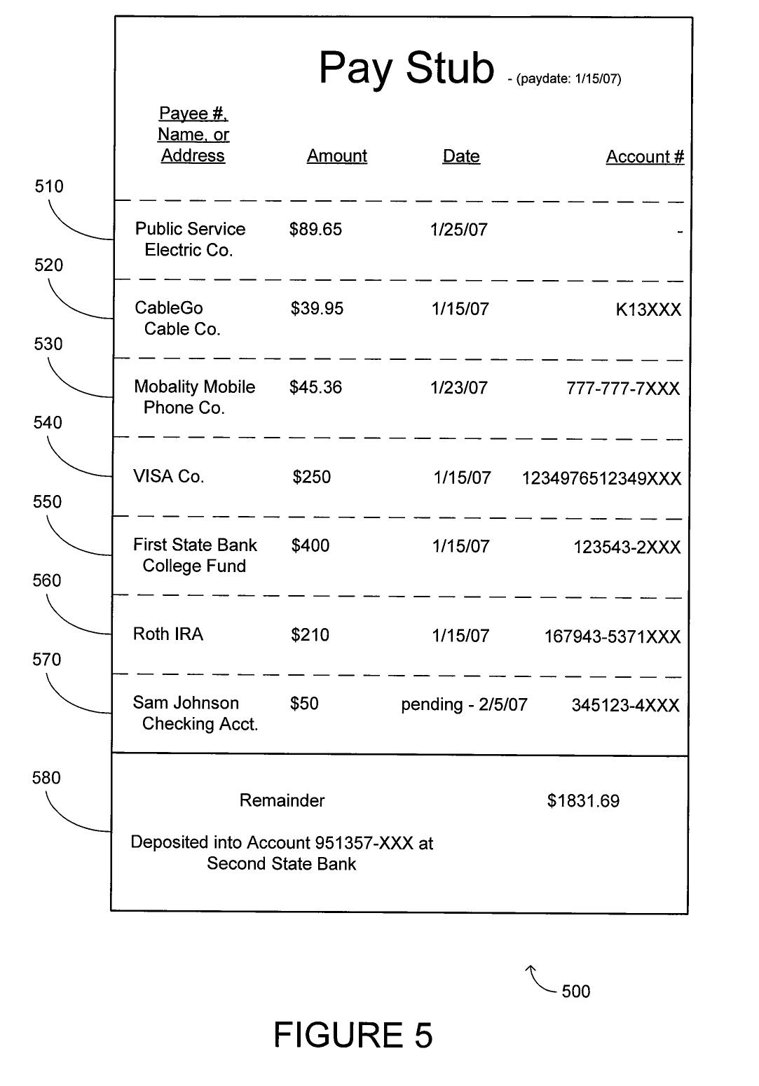

FIG. 5 is a sample set 500 of reports, shown in this embodiment as a pay stub. This set 500 of reports is an example of a report 170 that might be created by the reporting system 130 after the instructions 410, 420, 430, 440, 450, 460, 470 of FIG. 4 have been processed by the employee interface 110, the payroll system 120, and/or bill-pay system 310. In this embodiment, the reporting system 130 has, for reporting purposes, replaced the identifier representing the payee in instruction 410 with the name of the payee in report 510. This may make it easier for the employee 140 to identify where funds have been directed to. For other payees, this embodiment has also replaced the last three digits in any account number with X's for security purposes. Report 570 also shows that the direction of funds that was to occur in the future from instruction 470 as pending the date in the instruction 470.

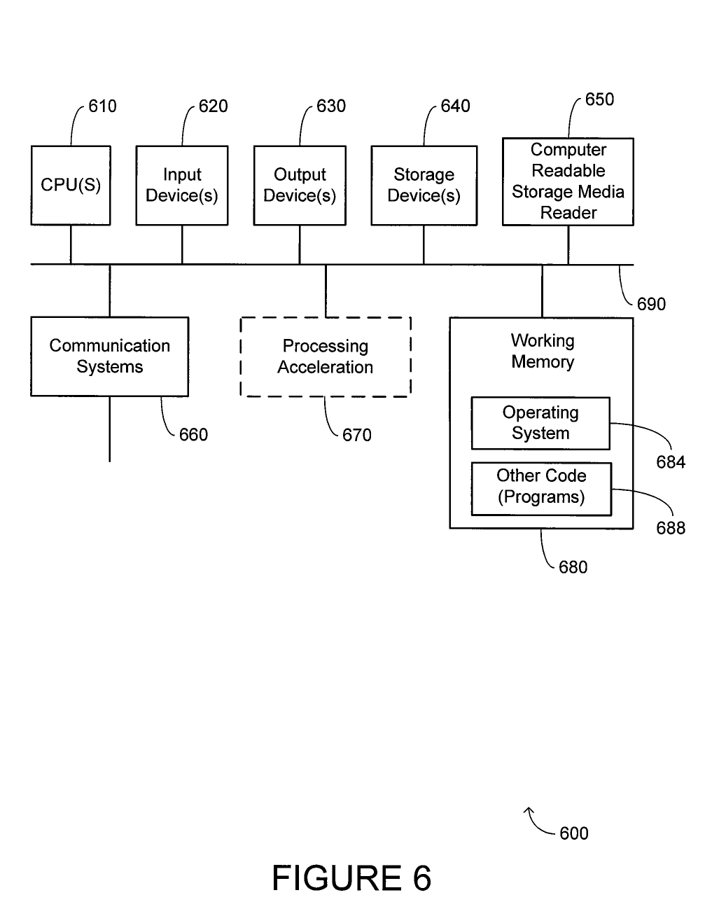

FIG. 6 is a block diagram illustrating an exemplary computer system 600 in which at least portions of embodiments of the present invention may be implemented. This example illustrates a computer system 600 such as may be used, in whole, in part, or with various modifications, to provide the functions of the employee interface 110, the payroll system 120, the reporting system 130, the bill-pay system 310, and/or other components of the invention such as those discussed above. For example, various functions of the payroll system 120 may be controlled by the computer system 600 including, merely by way of example, receiving instructions, directing funds, and/or communicating with the bill-pay system 310.

The computer system 600 is shown comprising hardware elements that may be electrically coupled via a bus 690. The hardware elements may include one or more central processing units 610, one or more input devices 620 (e.g., a mouse, a keyboard, etc.), and one or more output devices 630 (e.g., a display device, a printer, etc.). The computer system 600 may also include one or more storage device 640. By way of example, storage device(s) 640 may be disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 650, a communications system 660 (e.g., a modem, a network card (wireless or wired), an infra-red communication device, a Bluetooth™ device, etc.), and working memory 680, which may include RAM and ROM devices as described above. In some embodiments, the computer system 600 may also include a processing acceleration unit 670, which can include a digital signal processor, a special-purpose processor and/or the like.

The computer-readable storage media reader 650 can further be connected to a computer-readable storage medium, together (and, optionally, in combination with storage device(s) 640) comprehensively representing remote, local, fixed, and/or removable storage devices plus storage media for temporarily and/or more permanently containing computer-readable information. The communications system 660 may permit data to be exchanged with a network, system, computer, and/or other component described above.

The computer system 600 may also comprise software elements, shown as being currently located within a working memory 680, including an operating system 684 and/or other code 688. It should be appreciated that alternate embodiments of a computer system 600 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 600 may include code 688 for implementing any or all of the function of the various elements of the architecture as described herein. For example, software, stored on and/or executed by a computer system such as system 600, can provide the functions of the employee interface 110, the payroll system 120, the reporting system 130, the bill-pay system 310, and/or other components of the invention such as those discussed above. Methods implementable by software on some of these components will be discussed below in more detail.

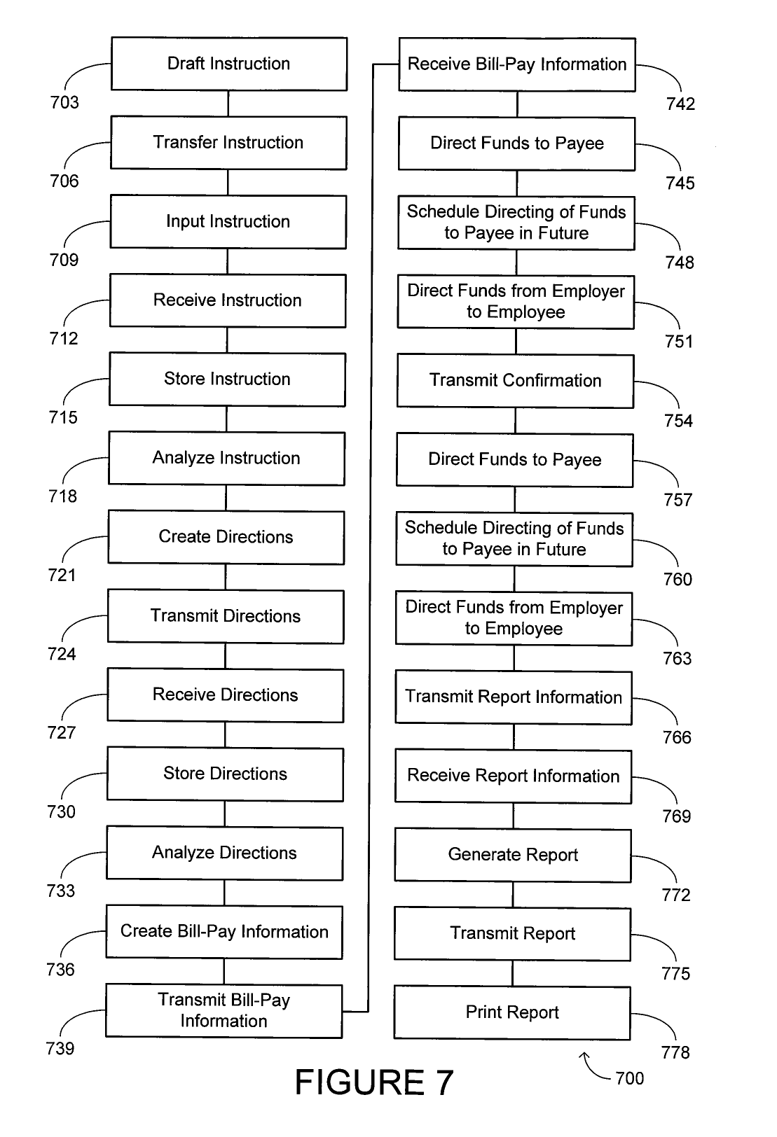

FIG. 7 is a flow diagram 700 of a method for managing an employee's funds that uses another person 220 to input instructions, and both a payroll system 120 and a bill-pay system 310 to direct funds. At block 703, an employee 140 drafts a paper instruction 210. The employee 140 then transfers the paper instruction 210 to another person 220 at block 706. At block 709, the other person 220 inputs the instruction from the paper instruction 210 into the employee interface 110. The employee interface 110 receives the instruction at block 712. At block 715, the employee interface 110 stores the instruction. The employee interface 110 analyzes the instruction to determine if there is an error at block 718. The error might be, merely by way of example, a data entry error, or that the instruction could request that funds be directed in an amount greater than would be available due to the employee 110 not being due the sum required at a pay-date of the employer 160. The employee interface 110 might return a message to the person who inputted the instruction notifying them of the error. This could occur real-time during entry of the instruction, or possibly afterwards, either at the employee interface 110, or via other means such as by paper mail or e-mail.

At block 718 the employee interface 110 creates directions based at least in part upon the instruction received by the user interface 110. The employee interface 110 then transmits the directions at block 724. At block 727, the payroll system 120 receives the directions. The payroll system 120 stores the directions at block 730. At block 733, the payroll system analyzes the directions for errors. The errors may be the same exemplary errors discussed above in regard to the instruction, or other errors such as improper account or payee identifiers. Responses to such errors may be similar to those made by the employee interface 110 to errors in the instruction as discussed above. Additionally, the payroll system may be able to correct errors by reassigning proper account or payee identifiers based upon other information provided by the payee.

At block 736, the payroll system 120 creates bill-pay information. This information contains information, similar to that included in the instruction, which allows a bill-pay system 310 to transfer funds from the employer 140 to the payee 150. The payroll system 120 transmits the bill-pay information at block 739. At block 742, the bill-pay system 310 receives the bill-pay information. The bill-pay system 310 directs funds to from the employer 160 to the payee at block 745. At block 748, the bill-pay system 310 schedules directing of funds from the employer 160 to the payee 150 in the future. In some embodiments the method may direct funds from the employer 160 to the employee 150 using the bill-pay system 310 at block 751. At block 754, the bill-pay system 310 transmits a confirmation that the directing of funds has been completed.

At block 757, the payroll system 120 directs funds from the employer 160 to the payee 150. In embodiments where the bill-pay system 310 is not used, this may be the primary system which directs funds. In other embodiments where the bill-pay system 310 is used, multiple instructions may result in the bill-pay system 310 directing some funds, and the payroll system 120 directing some funds. At block 760, the payroll system 120 schedules directing of funds from the employer 160 to the payee 150 at a future date. The payroll system directs funds from the employer 160 to the employee 140 at block 763. At block 766, the payroll system 120 transmits reporting information. The reporting system 130 receives the report information at block 769. At block 772 the reporting system 130 generates a report. The reporting system 130 transmits the report either to a system or device to print a paper report 170 at block 778, or to an end device used to display the report.

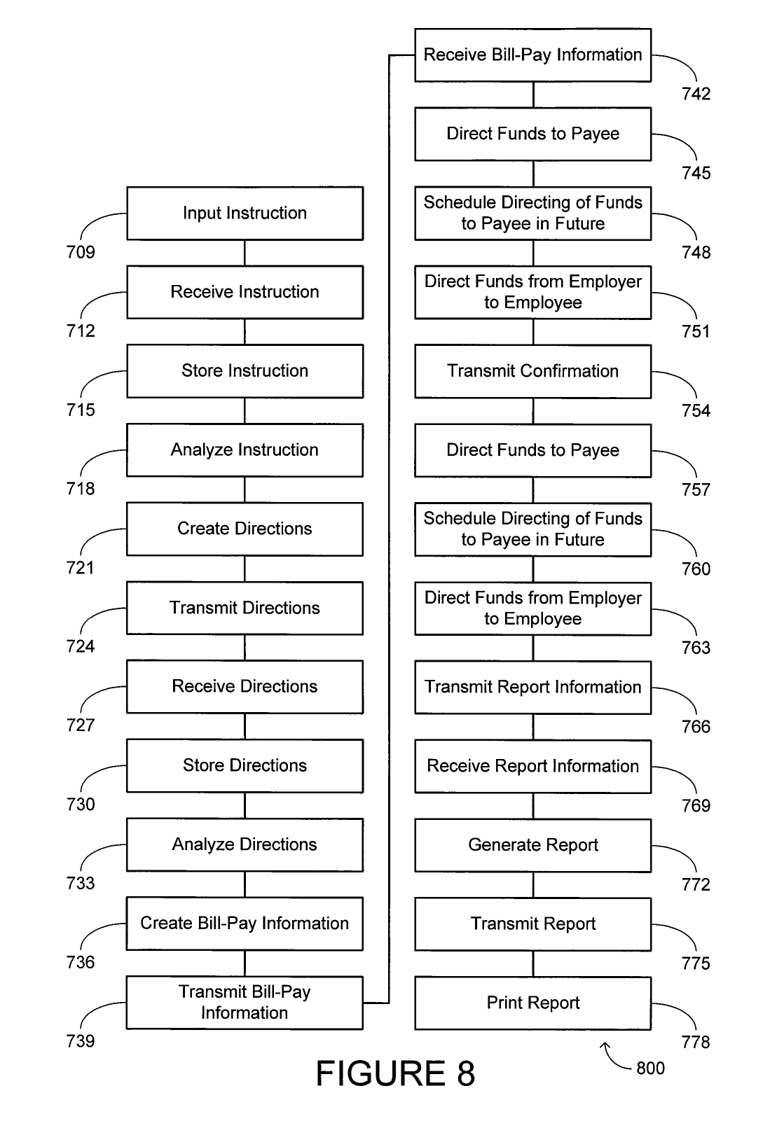

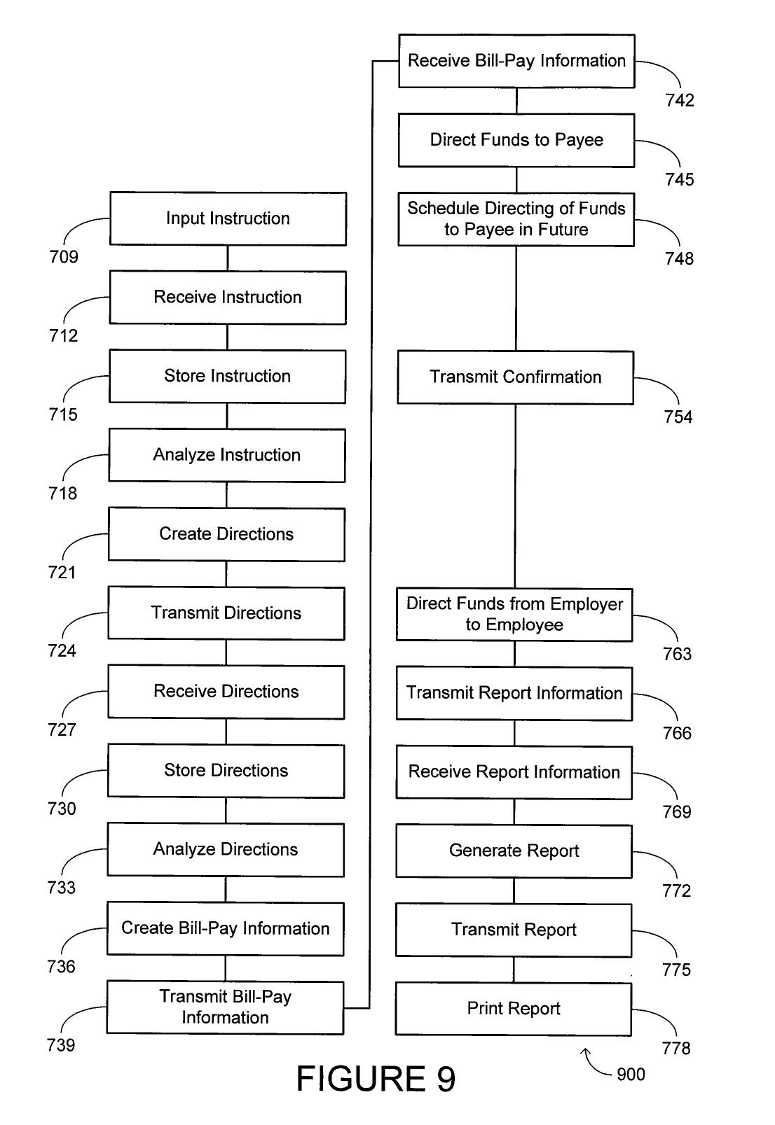

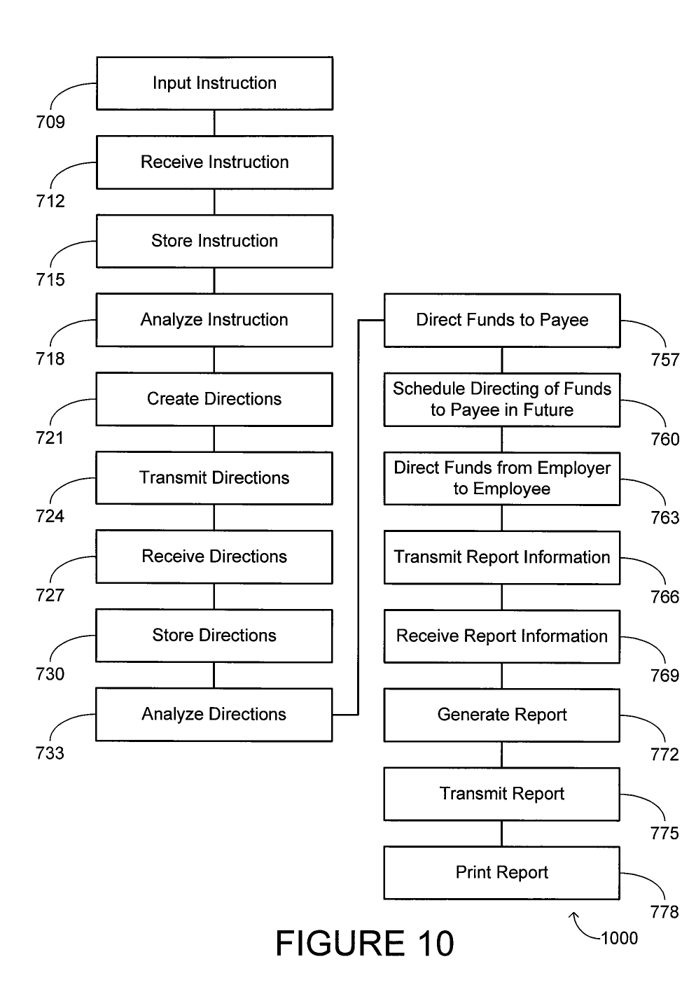

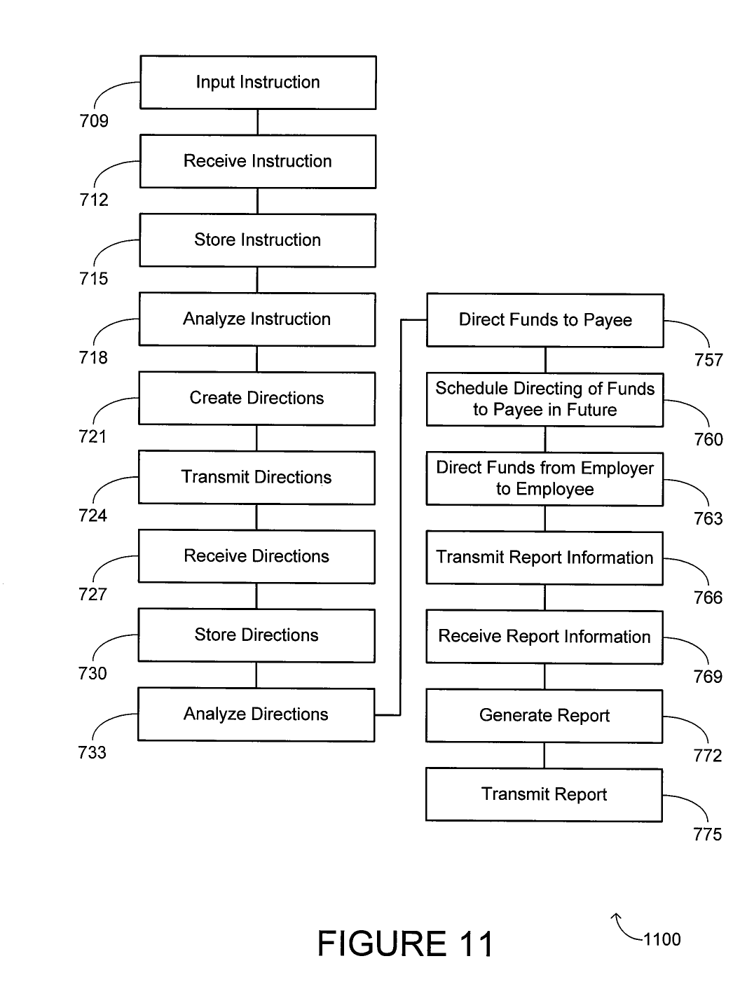

FIG. 8 is a flow diagram of the method in FIG. 7, except not using another person to input instructions. FIG. 9 is a flow diagram of the method in FIG. 8, except only using the bill-pay system to direct funds to a payee. FIG. 10 is a flow diagram of the method in FIG. 7, except only using the payroll system to direct funds. FIG. 11 is a flow diagram of the method in FIG. 10, except only transmitting a report electronically without producing a physical report.

A number of variations and modifications of the disclosed embodiments can also be used within the scope of the invention. For example, some of the embodiments discuss the report 170 being transmitted electronically to the employee 140. The electronic report 170 could be transmitted to the employee interface 110 in modified embodiments where the employee interface 110 is configured to receive and display the report 170. Another example of a modification to the proposed embodiments of the invention could include integrating the employee interface 110, the payroll system 120, and the reporting system 130, or some combination thereof, as subsystems of a larger system.

The invention has now been described in detail for the purposes of clarity and understanding. However, it will be appreciated that certain changes and modifications may be practiced within the scope of the appended claims.

What is claimed is:

1. A system for managing an employee's funds, the system comprising:
an employee interface, wherein the employee interface is configured to:
receive an instruction from an employee, wherein the instruction includes:
a first identifier representing a payee; and
an amount of funds to be directed to the payee; and
transmit directions, wherein the directions are based at least in part upon the instruction received from the employee;
a payroll system, wherein the payroll system is configured to:
receive directions transmitted from the employee interface;
based at least in part upon the directions, direct an amount of funds from an employer to the payee; and
based at least in part upon the directions, direct an amount of funds from the employer to the employee; and
a reporting system, wherein the reporting system is configured to produce a report, wherein the report includes:
a statement of the amount of funds directed from the employer to the payee; and
a statement of the amount of funds directed from the employer to the employee.

2. The system for managing an employee's funds of claim 1, wherein the employee interface comprises a computer.

3. The system for managing an employee's funds of claim 1, wherein receiving the instruction from the employee comprises a selection from a group consisting of:
the employee directly inputting the instruction into the employee interface; and
the employee writing the instruction and another person inputting the instruction into the employee interface.

4. The system for managing an employee's funds of claim 1, wherein the first identifier comprises a selection from the group consisting of:
an alpha-numeric code corresponding to the payee;
the payee's name; and
the payee's address.

5. The system for managing an employee's funds of claim 1, wherein the payee comprises a selection from the group consisting of:
an individual; and
a business entity.

6. The system for managing an employee's funds of claim 1, wherein the instruction further includes a second identifier representing an account payable to the payee and associated with the employee.

7. The system for managing an employee's funds of claim 1, wherein the instruction further includes a date, and the payroll system is further configured to direct the amount of funds from the employer to the payee relative to the date.

8. The system for managing an employee's funds of claim 1, wherein directing the amount of funds from the employer to the employee comprises producing at least one check payable to the employee.

9. The system for managing an employee's funds of claim 1, wherein directing the amount of funds from the employer to the employee comprises depositing funds into at least one account held by the employee at a financial institution.

10. The system for managing an employee's funds of claim 1, wherein the report comprises a selection from the group consisting of:
a paper report;
a pay stub;
an electronic report transmitted by e-mail to the employee; and
an electronic report viewable by the employee through a computer.

11. The system for managing an employee's funds of claim 1, further comprising a bill-pay system, wherein directing the amount of funds from the employer to the payee comprises the payroll system transmitting information for reception by the bill-pay system, and wherein the bill-pay system is configured to:
receive the information; and
direct the amount of funds from the employer to the payee based at least in part upon the information.

12. A system for managing an employee's funds, the system comprising:
an employee interface, wherein the employee interface is configured to:
receive an instruction from an employee, wherein the instruction includes a first identifier representing a payee to whom the employee owes an obligation; and
transmit directions, wherein the directions are based at least in part upon the instruction received from the employee;
a payroll system, wherein the payroll system is configured to:
receive directions transmitted from the employee interface;
based at least in part upon the directions and the obligation owed to the payee by the employee, direct an amount of funds from an employer to the payee; and
based at least in part upon the directions and the obligation owed to the payee by the employee, direct an amount of funds from the employer to the employee; and
a reporting system, wherein the reporting system is configured to produce a report, wherein the report includes:
a statement of the amount of funds directed from the employer to the payee; and
a statement of the amount of funds directed from the employer to the employee.

13. The system for managing an employee's funds of claim 12, wherein the instruction further includes a second identifier representing an account payable to the payee and associated with the employee.

14. The system for managing an employee's funds of claim 12, wherein the instruction further includes a date, and the payroll system is further configured to direct the amount of funds from the employer to the payee relative to the date.

15. The system for managing an employee's funds of claim 12, wherein the obligation has a due-date associated therewith, and the payroll system is further configured to direct the amount of funds from the employer to the payee relative to the due-date.

16. A method for managing an employee's funds, the method comprising:
receiving, at an employee interface, an instruction, wherein the instruction includes:
a first identifier representing a payee; and;
an amount of funds to be directed to the payee;
transmitting, from the employee interface, directions based at least in part upon the instruction received from the employee;
receiving, at a payroll system, the directions;
directing an amount of funds from an employer to the payee based at least in part upon the directions;
directing an amount of funds from the employer to the employee based at least in part upon the directions;
reporting the amount of funds directed from the employer to the payee; and
reporting the amount of funds directed from the employer to the employee.

17. The method for managing an employee's funds of claim 16, wherein the amount of funds directed from the employer to the payee is equal to an amount of an obligation owed to the payee by the employee.

18. The method for managing an employee's funds of claim 17, wherein the obligation has a due-date associated therewith, and the payroll system is further configured to direct the amount of funds from the employer to the payee relative to the due-date.

19. The method for managing an employee's funds of claim 16, wherein the instruction further includes a second identifier representing an account payable to the payee and associated with the employee.

20. The method for managing an employee's funds of claim 16, wherein directing, at the payroll system, the amount of funds from the employer to the payee comprises:
transmitting, from the payroll system, information for reception by a bill-pay system;
receiving, at the bill-pay system, the information; and
directing, at the bill-pay system, an amount of funds from the employer to the payee based at least in part upon the information transmitted from the pay roll system.
